(19) United States
(12) Patent Application Publication
(10) Pub. No.: US 2026/0213094 A1
(43) Pub. Date: Jul. 23, 2026

(54) ACTUATING UNIT AND ACTUATING ARRANGEMENT

(71) Applicant: Bury Sp.z.o.o., Mielec (PL)

(72) Inventor: Adam Knara, Borowa (PL)

(73) Assignee: Bury Sp.z.o.o., Mielec (PL)

(21) Appl. No.: 19/428,619

(22) Filed: Dec. 22, 2025

(30) Foreign Application Priority Data
Dec. 23, 2024 (DE) 10 2024 139 579.6

(51) Int. Cl. H01H 13/20; H01H 13/14

(52) U.S. Cl. CPC H01H 13/20; H01H 13/14

(57) ABSTRACT

Described is an activation unit having a first movable activation element and a second movable activation element which is coupled to the first movable activation element so as to displace itself to trigger an action owing to a displacement of the first activation element when activated by an activation force. The activation unit has a movable coupling element and an immovably fixed base element wherein the first and the second movable activation element are each connected to the coupling element in a spring-elastic manner, and the coupling element is connected to the base element in a spring-elastic manner.

The invention relates to an activation unit having a first movable activation element and a second movable activation element which is coupled to the first movable activation element so as to displace itself to trigger an action owing to a displacement of the first activation element when activated by an activation force.

The activation element provides a displacement element which is moved from one position to another by manual activation without mechanical parts exerting any frictional force on one another.

Switches or pushbuttons have to be activated in many real-life situations in order to trigger an action by way of manual activation. The task of a switch or pushbutton is primarily to establish an electrical contact when activated, and to release the electrical contact again when the pushbutton is released or the switch is reset. The electrical contact here can be used to directly switch on an operating means such as, for example, a motor, wherein the power consumed by the motor then flows by way of this pushbutton or switch. However, it is also possible to switch only a low current which actuates a relay, the power then flowing via the latter.

Not only is it possible to trigger an electrical contact, but also a mechanical function, as an action. For example, opening a car door can take place from the passenger cabin by activating a mechanical element, the latter then unlocking a door lock by transmitting the movement by way of a linkage. It is also possible to activate valves for selectively allowing liquids or pressurized gases to pass through.

A further task of the switch or pushbutton is to provide the operator with acoustic and/or haptic feedback to the effect that the contact is closed, or the function has been triggered, respectively. This is particularly important if the operating means to be switched cannot be directly seen or heard. In this instance, the acoustic or haptic feedback provides the operator with the certainty that the intended switching function has also actually been carried out. This feedback can be, for example, a clearly audible clicking sound or a haptically perceptible latching action.

The activation elements of a pushbutton or of a switch are typically of mechanical construction. The directly activatable element is either rotatably or displaceably mounted. A rotatably mounted element should move so as to be rotatable in only one direction; all attempts at moving the element in a different direction must be prevented by mechanical provisions. Typically, a rotating element has a hole in the center of rotation, a fixed axle running through the latter, this ensuring that only the rotational movement is permissible and all other activation attempts are suppressed.

In the case of linear activation, the activation element should be movable only in one direction; all attempts at exerting a force acting in a different direction on the activation element must be met with resistance. For this purpose, the activation element typically runs in a guide rail, the latter allowing that an activation in the longitudinal direction is possible but is robustly prevented in the transverse direction. An activation element of this type has a particularly appealing effect haptically when the movement in the longitudinal direction is very smooth and is blocked without play in the transverse direction, without giving the impression that the mechanism may flex.

A further requirement for the activation mechanism is maintaining the force/path characteristic in the entire temperature range and over the entire lifespan of the switch/pushbutton. Moreover, the characteristic is not to change when a force is exerted not only in the activation direction but also in a different direction. In the previously described examples such as, for example, the linear activation element, a protrusion of the activation element slides through a stationary groove or a hollow section, as a result of which the activation direction is predefined and also delimited to this extent. If a self-resetting pushbutton is to be implemented, the activation element is additionally connected to the fixed element by way of a spring. In the activation procedure, the spring is simultaneously tensioned, the spring pulling back the activation element to the initial position when the latter is released. The mechanism is imparted its typical haptic on account of the interaction between spring force and frictional force, this interaction always occurring when the protrusion of the activation element slides through the groove.

The spring force exerted by the elongated and contracted spring is substantially a function of the deflection of the spring. As long as the spring is not excessively elongated, it is also substantially independent of temperature and age. In contrast, the frictional force between the activation element and the groove in which the latter moves is a function of a raft of factors:
a) of the play between the activation element and the groove. The less play between the two elements, the higher the frictional force, in particular in the presence of an extremely minor play, or in the absence of any play. The play may also change as a result of temperature influences, for example as a result of the expansion of the protrusion upon heating.
b) of the viscosity of the lubricant between the protrusion of the activation element and the groove. The Viscosity May Also Change Along With the Temperature.
c) of environmental influences due to moisture and dust. An ingress of moisture or dust can significantly change the viscosity of the lubricant.
d) due to aging. A small amount of material, which then accumulates in the lubricant, is always subtracted due to friction during activation. It is the task of the lubricant to keep this material subtraction as low as possible; however, the subtraction cannot be completely prevented. Thus, the viscosity of the lubricant changes over the years of service, thus also changing the haptics during activation.

Furthermore known are mechanisms in which a fixed and a movable element are connected to one another by way of springs, and the direction in which the movable element can move relative to the fixed element is also controlled by way of springs. In particular, the movable element is connected to the fixed element by way of leaf springs. The advantage of this arrangement is that no parts rub against one another in the process. However, it is disadvantageous that the stiffness in directions other than the intended direction of movement, in particular in the z-direction, is not sufficiently high. Therefore, a further delimitation of movement in these directions is required, this again generating friction.

It is an object of the present invention to achieve an improved activation unit and an activation assembly formed therefrom.

The object is achieved by the activation unit having the features of claim 1, and by the activation assembly having the features of claim 11. Advantageous embodiments are described in the dependent claims.

It is proposed that the activation unit has a movable coupling element and an immovable fixed base element, wherein the first and the second movable activation element are each connected to the coupling element in a spring-elastic manner, and the coupling element is connected to the base element in a spring-elastic manner.

The activation unit avoids the above-mentioned disadvantages that are created by two elements sliding on one another in that there are no longer any parts that slide on one another. Instead, the spatially spaced-apart parts, specifically the first and the second movable activation element, the coupling element and the base element are disposed so as to be mutually spaced apart and are connected to one another in a spring-elastic manner.

However, all these parts are constructed so as to be in the two-dimensional plane (2D-plane). In this way, the stiffness in the z-direction, perpendicular to the 2D-plane, is less pronounced.

The first movable activation element can be connected at a first end region of the coupling element, and the second movable activation element can be connected at a second end region of the coupling element that lies opposite the first end region.

The base element can be disposed between the first movable activation element and the second movable activation element.

The coupling element can be connected to the first movable activation element, to the second movable activation element, and to the base element by spring-elastic arms.

The spring-elastic arms can extend so as to be substantially mutually parallel.

The activation unit can be board-shaped. The first movable activation element, the second movable activation element, the coupling element and the base element herein define one plane.

The second movable activation element can be coupled to an electric switch or pushbutton so as to open or close the electric pushbutton or switch by activating the first movable activation element by means of displacing the first movable activation element.

The activation unit can have a touch head which is movably mounted in a housing and which is coupled directly to the first movable activation element so as to displace the first movable activation element by impinging the first movable activation element with force by way of the touch head.

The first movable activation element and the second movable activation element can be fixedly connected to one another by way of a connecting element, wherein the connecting element is movable relative to the coupling element and to the base element.

The connecting element can be guided by a slot, for example of a housing, which extends in the direction from the first movable activation element to the second movable activation element, wherein a fastening dome (guide pin) extends through the slot, and the connecting element is movable only in the direction of longitudinal extent of the slot by way of the stroke delimited by the length of the slot.

The activation units can be disposed in the manner of tiers on top of one another.

The activation units stacked in tiers on top of one another form an activation assembly which is enlarged in the z-direction, perpendicular to the 2D-plane of the activation units, and due to the tiered stacking is mechanically more stable and stiffer than one activation unit.

The first movable activation elements, coupling elements, second movable activation elements and/or base elements disposed on top of one another can in each case be fixedly connected to one another.

The coupling elements of the respective activation units disposed directly on top of one another can be disposed so as to be alternately offset on opposite sides of the activation assembly. An even number of activation units are preferably stacked on top of one another so as to be alternately offset here in order to create a symmetrical arrangement.

The second movable activation element can be coupled to an electric switch or pushbutton so as to open or close the electric pushbutton or switch by activating the first movable activation element by means of displacing the first movable activation element and the second activation element coupled to the latter, and so as to form a manually or mechanically activatable electric switch or pushbutton.

The activation assembly can have a housing in which the plurality of activation units are received in tiers on top of one another, wherein movably mounted in the housing is a touch head which is coupled directly to the first movable activation element so as to displace the first movable activation element by impinging the first movable activation element with force by way of the touch head.

In the context of the present invention, the term “a” is understood to be an indefinite term and not a numeral, so that further features may be present unless this is expressly stated as a numeral in the sense of “exactly one” and not in the sense of “at least a”.

In the description hereunder, which also refers to the figures, the following applies:
a movement in the x-direction is a horizontal movement to the left or the right;
a movement in the y-direction is a vertical movement upward or downward;
a movement in the z-direction is a movement perpendicular to the surface on which the figure is plotted.

The invention will be explained in more detail hereunder using exemplary embodiments and the appended drawings. In the figures:

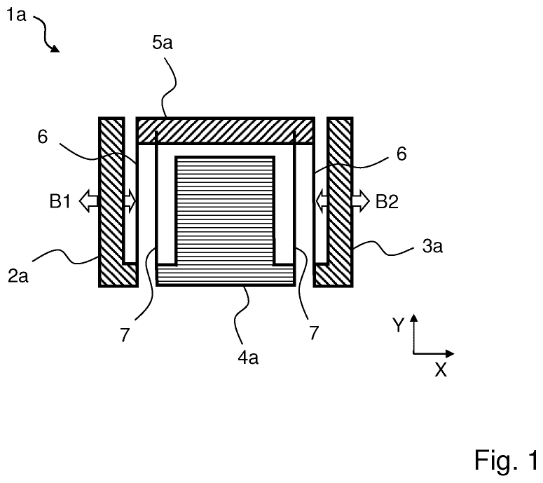

FIG. 1—shows a diagram of an activation unit in top view;

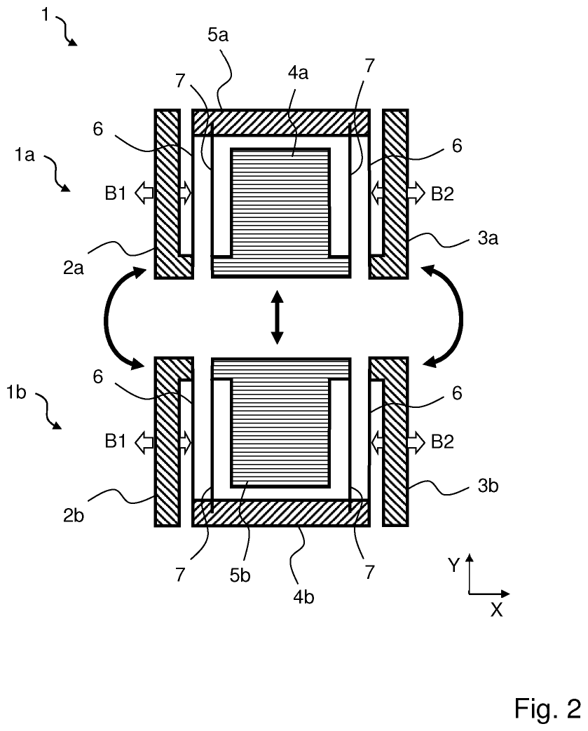

FIG. 2—shows a diagram of two activation units in top view, which are disposed so as to be mirrored on the 2D-plane, for stacking in tiers on top of one another and for connecting to one another in a positionally fixed manner the activation elements, the coupling elements and the base elements, respectively;

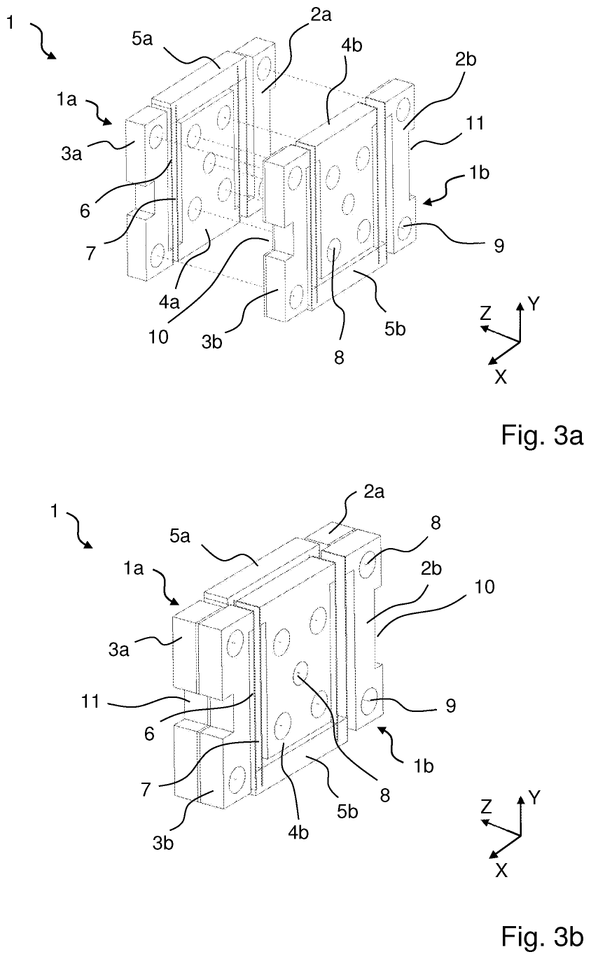

FIG. 3a—shows a perspective exploded view of an activation assembly having two activation units;

FIG. 3b—shows a perspective view of an activation assembly having two activation units which are aligned so as to be alternately offset and stacked on top of one another; and

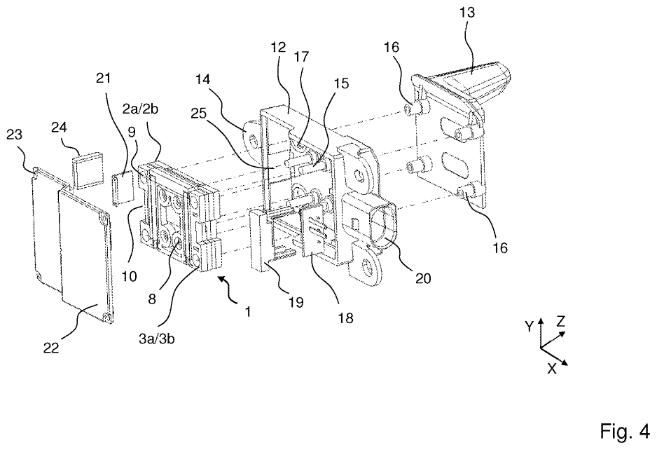

FIG. 4—shows a perspective exploded view of an actuator having a housing und an activation assembly installed in the latter.

FIG. 1 shows a diagram of an activation unit 1 in top view. It can be seen that the activation unit 1a has a first movable activation element 2a, a second movable activation unit 3a which is disposed opposite the latter at a spacing therefrom, a stationary base element 4a and a free coupling element 5a. The free coupling element 5a and the base element 4a are located between the two mutually spaced apart first and second movable activation elements 2a, 3a.

The first movable activation element 2a, at the end side of the coupling element 5a on the left in the image, is connected to the free coupling element 5a by a spring-elastic connecting element 6, for example in the form of a leaf spring. The second movable activation element 3a (on the right in the image), at the end side of the coupling element 5a on the right in the image, is connected to a further spring-elastic connecting element 6 (e.g. a leaf spring).

The stationary base element 4a and the free coupling element 5a are connected to one another by further spring-elastic connecting elements 7, for example in the form of leaf springs. In this way, the free coupling element 5a can be moved in the x-direction relative to the spatially fixed base element 4a. A movement in the y-direction and in the z-direction is impossible because the leaf springs 7 are correspondingly stiff in these axes and thus restrict those degrees of freedom. Twisting of the two elements, i.e. of the stationary base element 4a and of the free coupling element 5a, relative to one another is also impossible, because they are connected to one another at different points by the two leaf springs 7.

When a force B1 is exerted on the first movable activation element 2a (on the left in the image) in the x-direction toward the right, the latter transmits the force B1 via the leaf spring 6 to the free coupling element 5a. This coupling element 5a moves in the direction of the activation force B1 (i.e. to the right in the image) and transmits the movement via the leaf spring 6 to the second movable activation element 3a.

In this arrangement, the first movable activation element 2a can be somewhat twisted relative to the free coupling element 5a, because the activation force B1 exerted on the first movable activation element 2a may cause flexing of the leaf spring 6. Likewise, the second movable activation element 3a may also flex relative to the free coupling element 5a if a counter force acts on the second movable activation element 3a from the other side, i.e. from the right in the image, e.g. from the actuator element coupled to the latter, such as, for example, an electrical contact of a pushbutton or switch.

FIG. 2 shows a diagram of two activation units 1a, 1b in top view, which are disposed so as to be mirrored on the 2D-plane, for stacking in tiers on top of one another and for connecting to one another in a positionally fixed manner in each case the first movable activation elements 2a, 2b, the movable coupling elements 5a, 5b, and the stationary base elements 4a, 4b, respectively. It is thus possible to reduce the above-described risk of flexing of the movable activation elements 2a, 3a and to potentially even completely prevent such flexing. Presently, there is a first activation unit 1a as described in FIG. 1, and a second activation unit 1b which is mirrored vertically relative to the first activation unit 1a. Both activation units 1a, 1b are placed on top of one another in the z-direction, forming one activation assembly 1.

The fixed base elements 4a, 4b, the first (lefthand) movable elements 2a, 2b and the second (righthand) movable activation elements 3a, 3b are in each case connected to one another, for example by way of a form-fit or a force-fit. They can be screwed to one another, latched to one another, or be otherwise connected to one another. Only the free coupling elements 5a, 5b are not connected to one another. Owing to the alternately offset arrangement of the base elements 4a, 4b, said free coupling elements 5a, 5b are located at different mutually opposite positions.

FIG. 3a shows a perspective exploded view of an activation assembly 1 having two activation units 1a, 1b which are aligned in parallel and so as to be alternately mutually offset.

FIG. 3b shows a perspective view of the activation assembly 1 from FIG. 3a, having two activation units 1a, 1b which are aligned so as to be alternately offset and stacked on top of one another and are henceforth stacked in tiers directly on top of one another. The two activation units 1a, 1b here are connected to one another as described above.

It can be seen that in the event of a force B1 acting in the x-direction on the (lefthand) first movable activation elements 2a, 2b, the (lefthand) first movable activation elements 2a, 2b flex somewhat relative to the respective free movable coupling elements 5a, 5b, however flexing in mutually opposite directions. Because the two (lefthand) first movable activation elements 2a, 2b are rigidly connected to one another, flexing is no longer possible. The same applies in an analogous manner to the (righthand) second movable activation elements 3a, 3b.

Of course, more than two activation units 1a, 1b may also be stacked on top of one another and be connected to one another in the same manner.

As can be seen in the combined assembled activation assembly 1 in FIG. 3b, exerting a force B1 in the x-direction toward the right on the combined lefthand first movable activation element 2a, 2b causes a movement of the free coupling elements 5a, 5b and of the second movable activation elements 3a, 3b, in the actuator direction B2 toward the right. Exerting a force on the lefthand combined first movable activation elements 2a, 2b in the y-direction or z-direction does not cause any movement because the leaf springs 6, 7 are rigid and do not yield in those y-and z-directions.

It can likewise be seen that the leaf springs 6, 7 are in a resting position when no force is exerted. The counterforce generated by the leaf springs 6, 7 is linear in relation to the path of flexing, this meaning in terms of the overall system that the counterforce is linear in relation to the path of the movement in the x-direction.

Exerting a force on the (lefthand) first movable activation element 2a, 2b in the x-direction toward the right causes a movement of the two first movable activation elements 2a, 2b and of the free coupling element 5a, 5b likewise toward the right. The (righthand) second movable activation element 3a, 3b could activate a pushbutton, for example. Because the system is of a construction symmetrical in the x-direction, the effect of the force of the haptics of the pushbutton in the direction of the activation force B1 from right to left is converted into an actuator force B2. In this way, the system can be conceived in such a way that the pushbutton haptics can also be perceived on the (lefthand) first movable activation element 2a, 2b.

The (righthand) second movable activation element 3a, 3b can also trigger a contact in the absence of a force. For example, it can move past a contactless sensor such as, for example a Hall sensor. When the element is made of ferromagnetic material, the Hall sensor switches once a specific distance between the second movable activation element 3a, 3b and the Hall sensor has been undershot. This takes place without any mechanical intervention, completely without a force and without haptic feedback.

Assuming that all four leaf springs 6, 7 have identical spring parameters, in particular the same spring constant D, the following movement results when the (righthand) second movable activation element 3a, 3b activates a Hall sensor without exerting force:
An activation force B1 toward the right in the x-direction is exerted on the (lefthand) first movable activation element 2a, 2b.
As a result, the leaf spring 6 is tensioned and exerts the same force on the free coupling element 5a, 5b.
The at least one coupling element 5a, 5b likewise moves to the right, whereby it is subjected to the counterforce of the two leaf springs 6, 7.

Because the deflection of the leaf springs 6, 7 is relatively minor in relation to their length, it applies approximately that F=D*x, where F is the force, D is the spring constant, and x is the deflection in the x-direction. It applies to the (lefthand) first movable activation element 2a, 2b that F_{2a/2b}=D*x_{2a/2b} or the deflection x_{2a/2b}=F_{2a/2b}/D. Two leaf springs 7 which hold the coupling element 5a, 5b in each case on the fixed base element 4a, 4b so as to be movable relative thereto, act on the free coupling element 5a, 5b. This results in the deflection of the free coupling element 5a, 5b where x_{5a/5b}=F_{5a/5b}/(2*D). In a static system, there is an equilibrium of forces, such that the force F_{2a/2b}=F_{5a/5b}. This results in D*x_{2a/2b}=2*D*x_{5a/5b}. Therefore: x_{2a/2b}2*x_{5a/5b}. The operator of the element even has to move along the path x_{2a/2b} of the first movable activation elements 2a, 2b plus the path x_{5a/5b} of the free movable coupling elements 5a, 5b, because the free coupling elements 5a, 5b additionally move to the right in the direction of the activation force B1. Consequently, this arrangement performs a positive gearing of the path of the (lefthand) first movable activation element 2a, 2b of 3:1 in relation to the (righthand) second movable activation element 3a, 3b.

When a pushbutton, which requires a specific force, is activated by the (righthand) second movable activation element 3a, 3b, the positive gearing of the path becomes even larger. In this way, the relatively short activation path of a pushbutton can be geared to be a longer activation path at the pressure point by this arrangement. The force acting on the pushbutton and the haptics of the pushbutton are also transmitted from the actuator side, i.e. from the right in the image, to the activation side, i.e. to the left in the image. It can be seen from this example that different path gearings and force gearings can be implemented by way of the design embodiment of the leaf springs 6, 7 in terms of their spring constant D.

The dimensions of the individual elements in the z-direction can be as follows:
The fixed base elements 4a, 4b and the first and the second movable activation elements 2a, 2b, 3a, 3b have the same thickness, because they are connected to the corresponding elements.
The free movable coupling elements 5a, 5b and the spring-elastic connecting elements 6, 7 (e.g. leaf springs) should be somewhat thinner in the z-direction than the activation elements 2a, 2b, 3a, 3b and the base elements 4a, 4b, so that the former do not rub on adjacent elements, thus compromising the functionality, when being placed in layers.
The thickness of the last-mentioned elements can in principle be almost arbitrary. They need to be thick enough in order to be sufficiently stiff, and they must not be so thick that they generate frictional forces in conjunction with the adjacent elements.

No frictional forces whatsoever are required in the design embodiment of this movement mechanism, the mechanism therefore being independent of environmental influences in the form of dust and moisture, and of temperature influences and aging. This is a significant advantage in comparison to a general solution using a protrusion and a guide rail.

The fixed base elements 4a, 4b have retaining bores 8. For example, four retaining bores 8 are disposed so as to be mutually symmetrical, and a central retaining bore 8 may additionally be present. There should be at least two retaining bores 8 in order to secure the base elements 4a, 4b against rotation by means of retaining pins such as, for example, dowel pins inserted into the retaining bores 8.

The first and the second movable activation elements 2a, 2b, 3a, 3b can likewise have openings 9 into which dowel pins for connecting to an activation part can be introduced.

The retaining bores 8 and/or openings 9 can optionally have internal threads for receiving fastening screws.

The first movable activation elements 2a, 2b can have, on their side facing away from the fixed base element 4a, 4b, a recess 10 which can receive a protrusion of an activation part.

Likewise, the second movable activation elements 3a, 3b can have, on their side facing away from the fixed base element 4a, 4b, a recess 11 which can receive a protrusion of an actuator part or activation part.

As can be seen in FIG. 1, a single activation unit 1a, 1b consists of a fixed base element 4a, 4b, a free coupling element 5a, 5b, two movable activation elements 2a, 2b; 3a, 3b, and four spring-elastic connecting elements 6, 7 (e.g. leaf springs). The individual parts can consist of different materials. Thus, for example, the fixed base elements 4a, 4b, the free coupling elements 5a, 5b, and the movable activation elements 2a, 2b, 3a, 3b can be formed from plastics material, and the leaf springs 6, 7 can be formed from metal such as, in particular, spring steel with chromium alloy. Or else, the leaf springs 6, 7 can likewise be made of plastics material or of fiber-composite material such as carbon fiber or carbon. In this way, a single activation unit 1a, 1b according to FIG. 1 could be made using only one injection-molding tool, without further assembling of the individual elements any longer being required. The elements and the leaf springs 6, 7 may also consist of different plastics materials. Here too, a single activation unit 1a, 1b can be made using only one bi-component tool.

As can be seen from FIG. 3a, the overall assembly of the activation assembly 1 consists of two identical parts which are aligned and assembled so as to be mutually reversed (mirrored). Thus, both identical parts can be made using the same tool. This has the advantage that only one tool has to be built, and that the two parts, i.e. the activation units 1a, 1b, have only to be connected to one another by reversing them in order to obtain the overall mechanical unit. This is a significant simplification in comparison to the solution using a protrusion mounted in a guide rail.

FIG. 4 shows a perspective exploded view of an actuator having a basic housing 12 and an activation assembly 1 installed therein.

In this design embodiment, it is provided that the two movable pairs of activation elements 2a, 2b and 3a, 3b are fastened to an activation part 13, as illustrated in FIG. 4.

To be seen is the combined arrangement of the activation units 1a, 1b from FIG. 3b, forming a compact activation assembly 1 which can also be referred to as a motion module. Furthermore illustrated is the basic housing 12 which has laterally protruding fastening lugs 14 by way of which the basic housing 12 can be fixedly screwed to a platform such as, for example, a vehicle door. Four fastening domes 15 which plunge into the retaining bores 8 of the base elements 4a, 4b can be seen in the basic housing 12. The basic housing 12 is connected to the fixed base elements 4a, 4b by way of the fastening domes 15. The first and the second movable activation elements 2a, 2b; 3a, 3b of the motion module 1 are fastened to the activation part 13 by way of the four fastening domes 16 illustrated, which penetrate from the outside through slots 17 in the basic housing 12.

In this exemplary embodiment, the focus is not on the positive gearing of force and path from one side to another, but on holding the activation part 13 stably in position without a guide rail and on being able to move only in one movement axis x. This mechanism also operates without wear under all environmental conditions and is not subject to any notable aging.

Furthermore to be seen is a printed circuit board 18 with a pushbutton and externally protruding contact terminals. The printed circuit board 18 is fixedly connected to the basic housing 12, for example with the aid of a closure latch 19, and the pushbutton is positioned in such a way that the latter is activated by the pair of two movable activation elements 3a, 3b of the motion module 1. The deflection of the activation element 2a, 2b, 3a, 3b toward both sides is delimited by the size of the slots 17. The slots 17 can also be chosen in such way that the leaf springs 6, 7 are pre-loaded in the motion module 1. This is advantageous in terms of vibrations in the vehicle, because the activation part 13 moves only once a minimum force determined by the pre-load is exerted on the latter.

The basic housing 12 can have a laterally protruding plug connector receptacle duct 20 into which the contact terminals of the printed circuit board 18 protrude. A plug connector plugged into the plug connector receptacle duct can thus electrically contact the contact terminals and be held in its position by the plug connector receptacle duct 20.

The housing can have a housing cover 22 which is placed on the basic housing 12 and covers and closes the basic housing 12 with the activation assembly 1 installed in the latter. The housing cover 22 can be screwed to the basic housing 12 by means of fastening screws which are inserted through bores 23 on the four external edges, for example.

The pair of first activation elements 2a, 2b can be fixedly established in the y-direction on the basic housing 12 by way of a locking element 24. For this purpose, the locking element 24 plunges into the recess 10 of the first activation elements 2a, 2b and into a depression 25 on the adjacent internal wall of the basic housing 12. A lug 21 can be disposed between the locking element 24 and the end-side walls of the activation element 2a/2b that form the recess 10.

### LIST OF REFERENCE SIGNS

1a, 1b Activation unit
2a, 2b First movable activation element
3a, 3b Second movable activation element
4a, 4b Stationary base element
5a, 5b Free coupling element
6 Spring-elastic connecting element/leaf spring
7 Spring-elastic connecting element/leaf spring
8 Retaining bore
9 Opening
10 Recess
11 Recess
12 Basic housing
13 Activation part
14 Fastening lug
15 Fastening dome
16 Fastening dome
17 Slot
18 Printed circuit board
19 Closure latch
20 Plug connector receptacle duct
21 Lug
22 Housing cover
23 Bore
24 Locking element
25 Depression
B1 Activation force
B2 Actuator force/direction

1. An activation unit having a first movable activation element and a second movable activation element which is coupled to the first movable activation element so as to displace itself to trigger an action owing to a displacement of the first activation element when activated by an activation force,
wherein the activation unit has a movable coupling element and an immovably fixed base element, wherein the first and the second movable activation element are each connected to the coupling element in a spring-elastic manner, and the coupling element is connected directly to the base element in a spring-elastic manner.

2. The activation unit as claimed in claim 1, wherein the first movable activation element is connected at a first end region of the coupling element, and the second movable activation element is connected at a second end region of the coupling element that lies opposite the first end region.

3. The activation unit as claimed in claim 1, wherein the base element is disposed between the first movable activation element and the second movable activation element.

4. The activation unit as claimed in claim 1, wherein the coupling element is connected to the first movable activation element, to the second movable activation element, and to the base element by spring-elastic connecting elements.

5. The activation unit as claimed in claim 4, wherein the spring-elastic connecting elements extend so as to be substantially mutually parallel.

6. The activation unit as claimed in claim 1, wherein the activation unit is board-shaped and the first movable activation element, the second movable activation element, the coupling element, and the base element define one plane.

7. The activation unit as claimed in claim 1, wherein the second movable activation element is coupled to an electric switch or pushbutton so as to open or close the electric pushbutton or switch by activating the first movable activation element by means of displacing the first movable activation element.

8. The activation unit as claimed in claim 1, wherein the activation unit has a touch head which is movably mounted in a housing and which is coupled directly to the first movable activation element so as to displace the first movable activation element by impinging the first movable activation element with force by way of the touch head.

9. The activation unit as claimed in claim 1, wherein the first movable activation element and the second movable activation element are fixedly connected to one another by way of a connecting element, wherein the connecting element is movable relative to the coupling element and to the base element.

10. The activation unit as claimed in claim 9, wherein the connecting element is guided by a slot which extends in the direction from the first movable activation element to the second movable activation element, wherein a fastening dome extends through the slot, and the connecting element is movable only in the direction of longitudinal extent of the slot by way of the stroke delimited by the length of the slot.

11. An activation assembly having a plurality of activation units as claimed in claim 1, wherein the activation units are disposed in the manner of tiers on top of one another.

12. The activation assembly as claimed in claim 11, wherein the first movable activation elements, coupling elements, second movable activation elements and/or base elements disposed on top of one another are in each case fixedly connected to one another.

13. The activation as assembly as claimed in claim 11, wherein the coupling elements of the respective activation units disposed directly on top of one another are disposed so as to be alternately offset on opposite sides of the activation assembly.

14. The activation assembly as claimed in claim 11, wherein the second movable activation elements are coupled to an electric switch or pushbutton so as to open or close the electric pushbutton or switch by activating the first movable activation element by means of displacing the first movable activation element and the second activation element coupled to the latter, and so as to form a manually or mechanically activatable electric switch or pushbutton.

15. The activation assembly as claimed in claim 11, wherein the activation assembly has a housing in which the plurality of activation units are received in tiers on top of one another, wherein movably mounted in the housing is a touch head which is coupled directly to the first movable activation element so as to displace the first movable activation element by impinging the first movable activation element with force by way of the touch head.
